(19) United States
(12) Patent Application Publication
(10) Pub. No.: US 2025/0134629 A1
(43) Pub. Date: May 1, 2025

(54) DENTAL APPLIANCES, MATERIAL CONSTRUCTIONS AND IMPROVED TREATMENT SYSTEMS

(71) Applicant: Bay Materials, LLC, Fremont, CA (US)

(72) Inventors: Ray F. Stewart, Redwood City, CA (US); Rooz Khosravi, Fremont, CA (US)

(21) Appl. No.: 18/985,468

(22) Filed: Dec. 18, 2024

Related U.S. Application Data
(63) Continuation of application No. PCT/US2023/068997, filed on Jun. 23, 2023.
(60) Provisional application No. 63/354,998, filed on Jun. 23, 2022.

(51) Int. Cl. A61C 7/08; A61C 7/00

(52) U.S. Cl. CPC A61C 7/08; A61C 7/002

(57) ABSTRACT

Improved dental appliances and polymeric sheet compositions are disclosed. The polymeric sheet compositions are useful for making dental appliances having outer layers comprised of a material having a modulus of from about 1,000 MPA to 3,000 MPA (“hard”) and an inner core comprised of elastomeric material or materials having a modulus of from about 25 MPa to 500 MPa (“soft”) and a thickness of greater than about 250 microns, which exhibit improved flexibility and strength, and better stain and tear resistance than currently available materials and dental appliances.

### CROSS-REFERENCE TO RELATED APPLICATIONS

This patent application is a continuation of International Application PCT/US2023/068997 filed on Jun. 23, 2023, which claims the benefit of U.S. Provisional Patent Application No. 63/354,998, filed Jun. 23, 2022. Each of the afore-mentioned applications is incorporated by reference in its entirety for all purposes.

### FIELD

The present disclosure relates generally to systems and methods for sequentially moving teeth in orthodontic treatment, and more specifically to a combination of treatment procedures with aligners and materials having certain properties combined to provide enhanced tooth movements, and which provide a significant advancement on the state of art of clear aligner therapy.

### BACKGROUND

Clear aligner therapy involves the application of a series of one or more plastic “aligner” shells fitted to teeth. Each shell is formed so that it is displaced from one or more teeth such that the shell imparts forces to one or more teeth to move them toward a desired location different from their initial positions. The shells may be designed to move teeth in different directions, for example laterally, or rotationally, or in buccal or lingual directions or to produce intrusion or extrusion.

The shells are typically constructed from plastic sheets which are thermoformed over dental models representing each of the planned stages, or they may be fabricated by 3D printing. The shells (also commonly referred to as positioners or aligners) are either single layer materials, for example polyester co-polymers or polyurethanes, or may be multi-layer structures. Examples of single layer structures include PETG materials such as Essix Ace™ sold by Dentsply and ridged polyurethanes such a Zendura™ sold by Bay Materials, LLC. Examples of multilayer materials include SmartTrack™ aligners sold by Align technology and Zendura FLX™ sold by Bay Materials, LLC, see, e.g., U.S. Pat. Nos. 9,655,691, 9,655,693, 10,549,511, 10,946,630, 10,870,263 and 10,987,907, which are each incorporated by reference for all purposes. Other different multilayer aligner materials have been described in International Patent Publication No. WO 2020/225651, and WO2021025967A1, which are each incorporated by reference.

In some cases aligner therapy may involve using more than one type of material, for example two layer “hard/soft” materials (see for example orthocaps: https://www.orthocaps.com/was-is-orthocaps/#sec1) and a single layer “hard” material, or aligner therapy may use sequential appliances having different thicknesses (e.g., 0.5 mm, 0.625 mm. 0.75 mm) as in for example the CA Aligner system promoted by Scheu-Dental (Germany).

In clear aligner therapy a treatment plan is prepared, usually digitally, and specific amounts of movement are planned for each tooth (which can include one or more teeth not moving at all) for each step. Common tooth movements include simple translations (designated in mm per stage), rotations (designated in degrees per stage), tipping (designated in degrees per stage) and may be in buccal or lingual or mesial or distal or axial directions.

Due to the stress/strain properties of the prior art plastics such as polyester and rigid polyurethanes and the biomechanics of tooth movement, the amount of movement for a tooth at each stage for current aligner therapies has been limited to about 0.3 mm as a maximum. Greater attempted movements typically cause discomfort to the patient, may damage tooth roots or the jaw bone and typically result in inaccurate movements. Additionally, it is well known that attempting greater tooth movements per stage can result in increasingly large tooth movement lag. In the case of the “CA Aligner System”, greater movement may be programmed with the understanding that the actual movement is designed to be achieved over three sequential aligners so the effective movement per stage is still less than about 0.3 mm.

### SUMMARY

The present embodiments provide treatment systems for moving one or more teeth that advantageously enable a reduction in the number of aligners required to complete an orthodontic movement and advantageously allow for an expanded range of movement without causing pain or root damage. The present embodiments advantageously enable to predictably move teeth to a greater amount per stage of aligner treatment. The present embodiments advantageously enable to provide improved aligners and treatment plans enabling a reduction in the amount of materials used to fabricate appliances and/or reduced time to fabricate appliances.

In some embodiments, a dental appliance is adapted to sequentially position one or more teeth with fewer stages than prior aligner therapy plans. For example, various embodiments enable a reduction in the number of aligners for a therapy treatment plan determined, e.g., by a dental provider or automatically using dental treatment planning software, at a 1.25× to 1.5× or faster rate of tooth movement compared with prior systems.

According to an embodiment, a system for moving one or more teeth from a first location to at least a second location for treating malocclusion according to a treatment plan is provided. The system includes a series of one or more aligners wherein at least one of the aligners is comprised of a multilayer structure having at least two outer layers and at least one elastomeric inner layer, wherein the elastomeric inner layer has a thickness of greater than 250 microns up to about 1,000 microns, e.g., from about 300 microns to about 775 microns, and a hardness of from about Shore A80 to Shore D 65, wherein at least one of the outer layers comprises a polymer having a modulus of from about 1,000 MPa to about 3,000 MPa, and wherein a total thickness of the at least two outer layers and at least one elastomeric inner layer is from about 500 microns to about 1,500 microns. In an embodiment, the at least one of the aligners is configured and/or designed such that when worn for a wear time of between 10 and 15 days by a patient at least one tooth of the patient exhibits an offset movement in a mesial-distal direction and/or in a buccal-lingual direction of between about 0.35 mm to about 0.75 mm and/or at least one tooth of the patient exhibits a rotation about an axis of the at least one tooth of between about 3.5 degrees and about 7.5 degrees, and/or at least one tooth exhibits a mesial-distal tipping movement of between about 3.5 degrees and about 7 degrees.

According to another embodiment, a system for moving one or more teeth from a first location to at least a second location for treating malocclusion according to a treatment plan comprising two or more stages is provided. The system includes a series of one or more aligners wherein at least one of the aligners is comprised of a multilayer structure having at least two outer layers and at least one elastomeric inner layer, wherein the elastomeric inner layer has a thickness of greater than 250 microns up to about 775 microns and a hardness of from about Shore A80 to Shore D 65, wherein at least one of the outer layers comprises a polymer having a modulus of from about 1,000 MPa to about 3,000 MPa measured according to ASTM D638, wherein a total thickness of the at least two outer layers and at least one elastomeric inner layer is from about 500 microns to about 1,500 microns. In an embodiment, the at least one of the aligners is configured to effect, over the course of one treatment stage, one or more of an offset movement of least one tooth, a rotation of the at least one tooth and a mesial-distal tipping of the at least one tooth, wherein the offset movement is in a mesial-distal direction and/or in a buccal-lingual direction of between about 0.35 mm to about 0.75 mm, wherein the rotation is about a tooth axis of between about 3.5 degrees and about 7.5 degrees, and wherein the mesial-distal tipping movement is between about 3.5 degrees and about 7 degrees.

In an embodiment, the at least one of the aligners is configured such that when worn for the wear time by the patient two or more teeth of the patient each exhibit the offset movement of between about 0.35 mm up to about 0.75 mm.

In an embodiment, the at least one of the aligners is configured such that when worn for the wear time by the patient 8, 10, 12 or less teeth of the patient each exhibit the offset movement of between about 0.35 mm up to about 0.75 mm.

In an embodiment, the at least two outer layers each comprise a co-polyester, a polycarbonate, a polyester polycarbonate blend, a polyurethane, a polyamide or a polyolefin.

In an embodiment, the at least one elastomeric inner layer comprises one or more of a polyurethane elastomer, a polyolefin elastomer, a polyester elastomer, a styrenic elastomer, a polyamide elastomer, a cyclic olefin elastomer, an acrylic elastomer, an aromatic or aliphatic polyether polyurethane and a polyester polyurethane.

In an embodiment, the at least two outer layers each comprise a co-polyester.

In an embodiment, the at least one elastomeric inner layer has a modulus of from about 25 MPa to 500 MPa, e.g., 25 MPA, or 50 MPa, or 100 MPa, or 250 MPa, etc.

In an embodiment, the at least one aligner further comprises one or more tie layers.

According to another embodiment, a system for moving one or more teeth from a first location to at least a second location for treating malocclusion according to a treatment plan is provided, wherein the system includes a series of two or more aligners wherein each of the two or more aligners is comprised of a multilayer structure having at least two outer layers and at least one elastomeric inner layer, wherein the elastomeric inner layer has a thickness of greater than 250 microns up to about 1,000 microns, e.g., greater than 300 microns to about 775 microns, and a hardness of from about Shore A80 to Shore D 65, wherein at least one of the outer layers comprises a polymer having a modulus of from about 1,000 MPa to about 3,000 MPa, and wherein a total thickness of the at least two outer layers and at least one elastomeric inner layer is from about 500 microns to about 1,500 microns. In an embodiment, the at least one of the aligners is configured and/or designed such that when worn for a wear time of between 10 and 15 days by a patient at least one tooth of the patient exhibits an offset movement in a mesial-distal direction and/or in a buccal-lingual direction of between about 0.35 mm to about 0.75 mm and/or at least one tooth of the patient exhibits a rotation about an axis of the at least one tooth of between about 3.5 degrees and about 7 degrees, and/or at least one tooth exhibits a mesial-distal tipping movement of between about 3.5 degrees and about 7 degrees.

In an embodiment, each of the two or more aligners is configured such that when worn for the wear time by the patient two or more teeth of the patient each exhibit the offset movement of between about 0.35 mm up to about 0.75 mm.

In an embodiment, each of the two or more aligners is configured such that when worn for the wear time by the patient 8, 10, 12 or less teeth of the patient each exhibit the offset movement of between about 0.35 mm up to about 0.75 mm.

In an embodiment, the at least two outer layers each comprise a co-polyester, a polycarbonate, a polyester polycarbonate blend, a polyurethane, a polyamide or a polyolefin.

In an embodiment, the at least one elastomeric inner layer of each of the two or more aligners comprises one or more of a polyurethane elastomer, a polyolefin elastomer, a polyester elastomer, a styrenic elastomer, a polyamide elastomer, a cyclic olefin elastomer, an acrylic elastomer, an aromatic or aliphatic polyether polyurethane and a polyester polyurethane.

In an embodiment, the at least two outer layers of each of the two or more aligners each comprise a co-polyester.

In an embodiment, the at least one elastomeric inner layer of each of the two or more aligners has a modulus of from about 25 MPa to 500 MPa, e.g., 25 MPA, or 50 MPa, or 100 MPa, or 250 MPa, etc.

In an embodiment, each of the two or more aligners further comprises one or more tie layers.

In an embodiment, a novel aligner therapy treatment plan is determined by reducing a number of treatment stages in an initial treatment plan involving a first plurality of treatment stages each designed to effect an offset movement for at least one tooth of less than 0.3 mm, to a second plurality of treatment stages including the series of two or more aligners, wherein the number of treatment stages in the first plurality of treatment stages is greater than a number of treatment stages in the second plurality of treatment stages.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

The detailed description is described with reference to the accompanying figures. The use of the same reference numbers in different instances in the description and the figures may indicate similar or identical items

FIG. 1A is a schematic depiction of a cross sectional view of a three-layer sheet with a simple ABC construction. Layer A and layer C may be the same or different materials and each layer may be comprised of one or more materials, or blends or alloys. Layer B may be a single material, a blend of materials or alloys.

FIG. 1B is a schematic depiction of a cross sectional view of a multiple layer sheet. Each layer A, B and C, may be a comprised of a single layer or multiple layers and each layer may be comprised of one or more materials or a blend of materials. Layer A may be comprised of more than one layer, for example, layer a and a′, layer B may be comprised of more than one layer, for example, layer b and b′, and layer C may be comprised of more than one layer, for example, layer c and c′, as exemplified in FIG. 1B.

Additionally, the multilayer may comprise additional tie layers between different polymers as is known in the art.

FIG. 2 shows the elastic modulus and flexural modulus of four different aligner materials.

FIG. 3 shows an example of a treatment plan according to embodiments herein, including 3 upper aligners and 2 lower aligners formed using materials of the present disclosure and applied to a patient initially planned for 6 upper aligners and 4 lower aligner (number of stages reduced by 50%).

FIG. 4 illustrates a summary of tooth movement for the patient treatment plan in FIG. 5.

FIG. 5 shows an example of a relapse treatment plan according to embodiments herein, including 1 aligner for a conventional 2-stage treatment plan.

FIG. 6 illustrates a summary of tooth movement for the patient treatment plan in FIG. 5.

FIG. 7 shows an example of an incisor relapse treatment plan according to embodiments herein, including 2 aligners for a conventional 6-stage treatment plan.

FIG. 8 illustrates a summary of tooth movement for the patient treatment plan in FIG. 7.

### DETAILED DESCRIPTION

The present disclosure relates to materials, systems and methods of moving teeth using one or more clear aligners comprising aligners having three or more layers including at least two rigid outer materials and an inner elastomeric material and staged movement of one or more teeth of from about 0.35 mm to 0.8 mm and/or rotation of about 3.5 degrees to 8 degrees per stage. For example, in an embodiment, at least one aligner in a set of aligners provides for a tooth movement velocity of at least one tooth of greater than 0.35 mm in a 10 day period, or greater than 0.35 mm in a 14 day period, when consistently worn by a patient or user during that time period. Movement may be in the mesial/distal direction and/or in the buccal/lingual direction.

Further, in an embodiment, at least one aligner in a set of aligners provides for a tooth rotation velocity of at least one tooth about an axis (e.g., the long axis) of that tooth of greater than 0.35 degrees in a 10 day period, or greater than 3.5 degrees in a 14 day period, when consistently worn by a patient or user during that time period. Further, in an embodiment, at least one aligner in a set of aligners provides for a tooth translational velocity of at least one tooth about a center of resistance of that tooth of greater than 0.35 degrees in a 10 day period, or greater than 3.5 degrees in a 14 day period, when consistently worn (e.g., at least 18 hours of wear per day) by a patient or user during that time period.

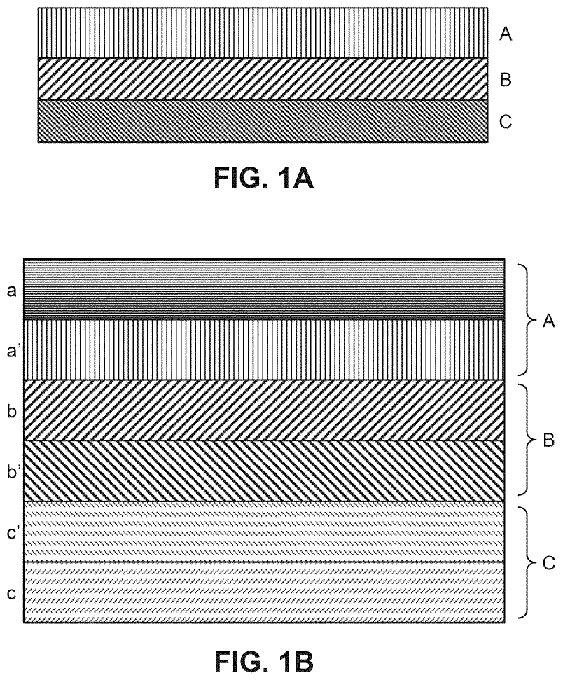

FIG. 1A is a schematic depiction of a cross sectional view of a three-layer sheet with a simple ABC construction. Layer A and layer C may be the same or different materials and each layer may be comprised of one or more materials, or blends or alloys. Layer B may be a single material, a blend of materials or alloys.

FIG. 1B is a schematic depiction of a cross sectional view of a multiple layer sheet. Each layer A, B and C, may be a comprised of a single layer or multiple layers and each layer may be comprised of one or more materials or a blend of materials. Layer A may be comprised of more than one layer, for example, layer a and a′, layer B may be comprised of more than one layer, for example, layer b and b′, and layer C may be comprised of more than one layer, for example, layer c and c′, as exemplified in FIG. 1B.

The three layer sheets of FIG. 1A and the multi-layer sheets of FIG. 1B may be used to form dental appliances, e.g., aligners, in accordance with various embodiments herein.

In one embodiment, a composition comprised of at least two outer layers A and C and a middle layer B is provided. The A and C layers individually comprise a polymer, e.g., thermoplastic polymer, having a modulus of from about 1,000 MPa to 3,000 MPa and a glass transition temperature and/or melting point of from about 80° C. to 180° C. and the middle B layer is comprised of at least an elastomer having a modulus of from about 25 MPa to about 500 MPa and one or more of a glass transition temperature and/or melting point of from about 90° C. to about 220° C.

In one embodiment, the A and C layers are comprised of one of more of a co-polyester, a polycarbonate, a polyester polycarbonate blend, a polyurethane, a polyamide or a polyolefin.

In an embodiment, the middle B layer is comprised of one or more of a polyurethane elastomer, a polyolefin elastomer, a polyester elastomer, a styrenic elastomer, a polyamide elastomer, a cyclic olefin elastomer, an acrylic elastomer, an aromatic or aliphatic polyether polyurethane or a polyester polyurethane or a polycarbonate polyurethane.

In one embodiment the aligners have a tensile modulus of from about 600 to about 1000 MPa and a flexural modulus of from about 1100 to about 1400 MPA.

In one embodiment the aligner may comprise five or more layers, including two or more elastomeric layers (see, e.g., FIG. 1B). In one embodiment the total thickness of elastomeric materials is from about 450 or 500 microns to 1000 microns or greater, or 650 to 1000 microns, or 750 to 1000 microns.

In one embodiment, one or more teeth may be programmed or staged to move during any one stage. For example, in an embodiment, greater than 3 but less than 10 teeth are programmed or staged to move more than 0.35 mm or more than 0.4 mm per stage. In an embodiment, a maximum movement should be no more than about 7.5 mm or 8.0 mm per stage. The individual or cumulative tooth movements may be in the mesial/distal direction and/or in the buccal/lingual direction.

Table 1 and Table 2 are charts showing examples of movements (Table 2) based on examples of aligner material design (Table 1) where A and C layers are outer layers, and the B layer is an inner or middle layer.

TABLE 1
Layer thickness (microns)

| | | Zendura | FLX | Ex. 1 | Ex. 2 | Ex. 3 | Ex. 4 |
|---|---|---|---|---|---|---|---|
| Hard | A | 762 | 254 | 254 | 254 | 127 | 127 |
| Soft | B | 0 | 254 | 381 | 508 | 635 | 762 |
| Hard | C | 0 | 254 | 254 | 254 | 127 | 127 |
| | Total | 762 | 762 | 889 | 1016 | 889 | 1016 |
| Max | | 300 | 300 | 500 | 700 | 800 | 1000 |
| movement | | | | | | | |
| (mm) | | | | | | | |
| Ratio of | | | 1.18 | 1.31 | 1.38 | 1.26 | 1.31 |
| movement | | | | | | | |
| to | | | | | | | |
| elastomer* | | | | | | | |

*Assuming moving not more than 10 teeth

TABLE 2

| | This table discusses the thresholds for the range of | | | | | | | | | |
|---|---|---|---|---|---|---|---|---|---|---|
| | transitional movement per stage as a function of | | | | | | | | | |
| Max | the number of teeth based on clinical findings | | | | | | | | | |
| mm/tooth | 1 | 2 | 3 | 4 | 5 | 6 | 7 | 8 | 9 | 10 |
| 0 | A | A | A | A | A | A | A | A | A | A |
| 0.1 | A | A | A | A | A | A | A | A | A | A |
| 0.2 | A | A | A | A | A | A | A | A | A | A |
| 0.3 | A | A | A | A | A | A | A | A | A | A |
| 0.4 | A | A | A | NR | NR | NR | NR | NR | NR | NR |
| 0.5 | A | A | NR | NR | NR | NR | NR | NR | NR | NR |
| 0.6 | NR | NR | NR | U | U | U | U | U | U | U |
| 0.7 | U | U | U | U | U | U | U | U | U | U |
| 0.8 | U | U | U | U | U | U | U | U | U | U |

Acceptable (A): a common standard practice by majority of aligner manufacturers and clinicians.
Not Recommended (NR): The patient will experience pain and the biological mechanism of tooth movement towards undermining resorption will be compromised, resulting in an inefficient tooth movement protocol.
Unfavorable (U)

In one embodiment, one or more teeth may be programmed or staged for rotation and/or tipping during any one stage. For example, in an embodiment, greater than 3 but less than 10 teeth are programmed or staged to rotate or tip more than 3.5 degrees or more than 4 degrees per stage. In an embodiment, a rotation, or angular tipping, movement should be no more than about 7.5 degrees or 8.0 degrees per stage.

In one embodiment, one or more teeth may be programmed or staged to move axially (e.g., extrusion or intrusion movement) during any one stage. For example, in an embodiment, greater than 3 but less than 10 teeth are programmed or staged to move more than 0.3 mm or more than 0.4 mm per stage.

To determine staging of a tooth, treatment planning software executing on a computer system may be used. The automated treatment planning software takes initial tooth locations and final tooth locations and establishes the difference, for example, a difference of 1 mm or 10 mm. The software then can be given a “maximum movement per stage limit, for example 0.3 mm”. The software then generates intermittent stages (the case plan) to move the teeth to that location and orientation. Advantageously embodiments of the present disclosure are particularly useful for users that may desire an adjusted plan with a higher range of tooth movement. Embodiments herein enable an increase in both linear and angular range of tooth movement per stage of aligner therapy, and improved control over the number of stages (e.g., in some instance a reduced set of stages) to produce the desired outcome (final tooth locations and orientations) compared with prior aligner therapy plans. For example, tooth velocities at 1.5× or 2.0× faster rate of tooth movement are possible using the higher elasticity layer structures described herein.

In one embodiment, the combined thickness of the A, B and C layers is from about 250microns to about 2,000 microns, or from about 500 microns to about 1500 microns.

In an embodiment, the middle B layer comprises an aromatic polyether polyurethane having a Shore hardness of from about A90 to D55, from about A85 to D60, or from about A80 to D65, and a compression set of less than 35%, wherein the interlayer peel strength between the A and C layers and the B layer is greater than 50 N per 2.5 cm. The term “peel strength” may be measured according to ASTM D3163. The specification for a useful material, Trilaminate PN 9210 Extrusion-Lamination & Slit Rolls, is: Interlayer bonding, ASTM D3163, Peel force>50N; 2.54 cm. The term “compression set” is used herein with reference to the permanent deformation of a material when a force is applied and removed. Unless specified otherwise, compression set is measured according to ASTM D 395-B (ISO 815) at specified time and temperature of 22 hours at 23° C.

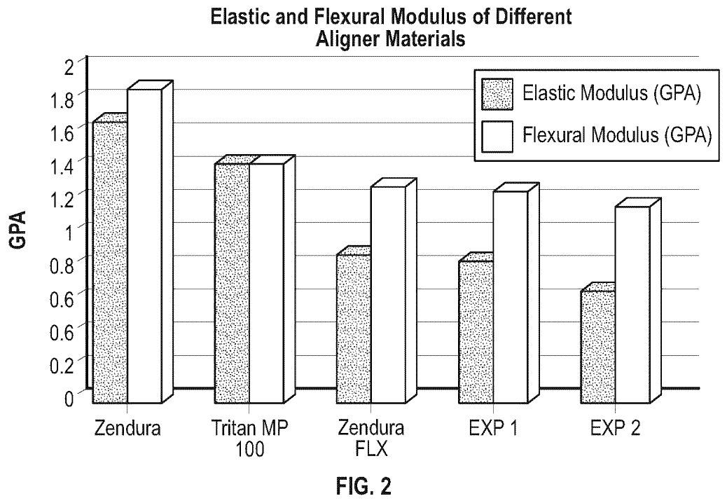

FIG. 2 shows the elastic modulus and flexural modulus of five different aligner materials as also shown in Table 3 below:

TABLE 3

| | Elastic | Flexural | | Composition | | |
|---|---|---|---|---|---|---|
| | Modulus | Modulus | | (Construc- | Total | |
| Material | (GPA) | (GPA) | Supplier | tion) | Thickness | |
| Zendura | 1.7 | 1.9 | Bay | Aromatic | 0.76 | mm |
| | | | Materials | Polyurethane | | |
| | | | | (Monolayer) | | |
| Tritan | 1.45 | 1.45 | Eastman | Cyclo- | 0.76 | mm |
| MP 100 | | | Chemical | aliphatic | | |
| | | | | Copolyester | | |
| | | | | (Monolayer) | | |
| Zendura | 0.9 | 1.31 | Bay | Three layer | 0.76 | mm |
| FLX | | | Materials | (1:1:1) | | |
| | | | | polyester/ | | |
| | | | | poly- | | |
| | | | | urethane/ | | |
| | | | | polyester | | |
| EXP 1 | 0.86 | 1.28 | Bay | Three layer | 0.89 | mm |
| | | | Materials | (1:1.5:1) | | |
| | | | | polyester/ | | |
| | | | | poly- | | |
| | | | | urethane/ | | |
| | | | | polyester | | |
| EXP 2 | 0.68 | 1.19 | Bay | Three layer | 1 | mm |
| | | | Materials | (1:2:1) | | |
| | | | | polyester/ | | |
| | | | | poly- | | |
| | | | | urethane/ | | |
| | | | | polyester | | |

In one embodiment, one or multiple dental appliances, each conformal to one or more teeth made from a composition or a polymeric sheet as described herein are provided.

In one embodiment of the dental appliance the combined thickness of the A, B and C layers is from about 300 microns to about 1,500 microns and the combined thickness of the A and C layers is from 25 microns to 750 microns, from 50 microns to 1000 microns, from 100 microns to 700 microns, from 150 microns to 650 microns, from 100 microns to 200 microns, or from 200 microns to about 600 microns. The B layer thickness is from about 250 microns to about 1000 microns.

In one embodiment, the elastomeric middle layer comprises a polyurethane or polyester elastomer having a hardness of from about A 80 to D 75, A 85 to D 65, or A 90 to D 55, e.g., A95, A90, A85, A80, A75, D50, D55, D60, D65 or D70.

In another embodiment, a composition, polymeric sheet or dental appliance having environmental stress resistance comprised of at least two outer layers and an elastomeric inner layer, wherein one or more of the outer layers is a polyester or co-polyester having a modulus of from about 1,000 MPa to 3,000 MPa, and the inner layer comprises an elastomer having a modulus of from about 25 MPa to about 500 MPa, wherein the inter layer peel strength between at least one outer layer and the elastomer is greater than about 50 N/inch, is provided.

In another aspect, a reversibly deformable dental appliance is provided, wherein the thickness of the outer A layer is from about 100 microns to about 250 microns, e.g., 100 microns, 125 microns, 150 microns, 175 microns, 200 microns, 225 microns or 250 microns, the thickness of the outer C layer is from about 100 microns to about 250 microns, e.g., 100 microns, 125 microns, 150 microns, 175 microns, 200 microns, 225 microns or 250 microns, and the thickness of the middle B layer is greater than about 250 microns, e.g., from 300 to 1000 microns, wherein the combined thickness of the A, B and C layers from 450 to 1,500 microns or greater.

In some embodiments, thin layers of additional polymers (tie layers) may be present to improve the adhesion of polymer layers that are not naturally adhesive to each other for example a layer of maleic anhydride grafted polypropylene may be used to increase the adhesion between a polypropylene A layer and polyester or polyamide B layer. Other tie materials may include copolymers of ethylene and acrylic esters and or vinyl acetate, ethylene graft maleic anhydride, ethylene co acrylic acid optionally containing other alpha olefins.

In some embodiments, a set of one or more dental appliances may be formed by thermoforming a multilayer sheet over a model of teeth wherein thermoforming is performed at a temperature that is at least greater than the glass transition temperature and/or melting point of the outer layers and greater than or equal to the upper glass transition temperature and/or melting point of at least an inner layer material, e.g., elastomer material.

It should be understood that elements of two or more embodiments may be combined.

In some embodiments, a dental appliance is adapted to sequentially position one or more teeth with fewer stages than prior aligner therapy plans, due, at least in part to the increased elasticity as a result of the combination of layer thicknesses and hardness properties.

If one hard outer layer is thinner than another hard outer layer, thermoforming the thinner hard layer against a model can provide improved contact and conformity to the model increasing comfort, fit, and mechanical force coupling.

In some embodiments, a tooth-contacting hard outer layer on the inside of an appliance has a thickness that is less than another hard layer (e.g., asymmetric).

In some embodiments, the thickness of the tooth-contacting hard layer can be less than about 250 microns or as thin as about 50 microns.

In certain embodiments, multilayer sheets may be prepared by a number of means including without limitation, hot or cold lamination, adhesive lamination, melt lamination, coextrusion, multilayer extrusion or other known methods. Sheets may be fully prepared before forming into an orthodontic appliance, or an appliance may be produced using a sequence of individual thermoforming steps to create multiple layers.

Thermoforming of sheets to produce test samples or dental appliances may be performed using a “Biostar” pressure former available from Great Lakes Orthodontics using procedures commonly used in the industry. Alternatively, thermoforming may be performed using a roll fed thermoformer, a vacuum former or other known thermoforming techniques. Thermoforming may be conducted using different conditions, forms or models to vary draw ratio and part thickness. Multilayer appliances may be fabricated through one or more 3D printing processes or by sequential dip coating, spray coating, powder coating or similar processes known for producing films, sheets and 3D structures.

### Definitions

The term “dental appliance” is used herein with reference to any device placed in or on the teeth of a subject. Dental appliances include but are not limited to orthodontic, prosthetic, retaining, snoring/airway, cosmetic, therapeutic, protective (e.g., mouth guards) and habit-modification devices. One example of a dental appliance is an aligner, e.g., clear aligner.

The term “flexural modulus” is used herein with reference to the rigidity of a material and/or resistance of the material to deformation in bending. The higher the flexural modulus of the material, the more resistant to bending it is. For an isotropic material the elastic modulus measured in any direction are the same.

The term “hardness” is used herein with reference to a Shore hardness scale, and unless otherwise stated is measured according to ASTM D 2240. A durometer measures the penetration of a metal foot or pin into the surface of a material. There are different durometer scales, but Shore A and Shore D are commonly used. Materials with higher durometer values will be harder compared to materials with a lower durometer value. Shore hardness and modulus are generally correlated and can be converted by approximation if only one value is known by methods described in the art.

The expressions “modulus,” “Young's modulus” and “elastic modulus” are used herein with reference to the rigidity of a material and/or resistance of the material to stretching. The higher the modulus of the material, the more rigid. The flexural modulus and elastic modulus of a material may be the same or different. For isotropic materials such as A, B and C, components flexural modulus and modulus (which may also be referred to as elastic modulus) are substantially the same and one or the other may be measured dependent upon the circumstances. For laminated structures, the elastic modulus and flexural modulus may be significantly different. For polymers, the mechanical properties including elastic modulus and other properties may be measured as proscribed by ASTM D 638. Flexural modulus may be measured by the test listed in ASTM D790), and uses units of force per area. Unless designated otherwise, “modulus” refers to elastic modulus.

The term “polymeric sheet” is used interchangeably herein with the term “plastic sheet”.

The term “about,” as used herein with reference to a numerical value means the value may be within a small (e.g., no more than 10%) percentage of the value, e.g., within 10% or 5% or 2%, For example, “about 50” may include 45 to 55 and about 3000 may include 2700 to 3300.

The term “shell” is used herein with reference to polymeric structures which fits over the teeth and are removably placeable over the teeth.

The term “thermoplastic polymer” is used herein with reference to a polymer is a polymer that becomes pliable or moldable above a specific temperature and solidifies upon cooling, provided that the heat and pressure do not chemically decompose the polymer.

The terms “tooth” and “teeth” include natural teeth, including natural teeth which have been modified by fillings or by crowns, implanted teeth, artificial teeth that are part of a bridge or other fitting secured to one or more natural or implanted teeth, and artificial teeth that are part of a removable fitting.

The term “stage” is used herein to mean one or more steps in a treatment plan, each “stage” being represented by an aligner. A treatment plan may comprise one or more stages, for examples 10 stages, each stage being a proposed tooth movement converted into an aligner. The wear duration of a “stage” refers to the length of time a patient wears a specific set (one or two) aligners, for example, 5,7, 10 or 15 days. Multiple stages are typically combined to provide extended and/or multiple tooth movements, rotations, etc.

### EXAMPLES

Table 4, below, illustrates an example of linear and angular movements possible depending on the dimension of elastic inner layer B.

TABLE 4

| | Linear Movements | Angular Movements |
|---|---|---|
| | (micron) | (degree) |
| <250 micron inner layer B | 200-300 | 2.0-2.5 |
| >250 micron inner layer B | 350-750 | 3.5-7.0 |

Table 5, below, illustrates an example of reductions in stages possible according to embodiments.

### Example of a Treatment Plan

TABLE 5

| | A conventional aligner system | The system of claim 1 |
|---|---|---|
| Number of upper | 16 aligners | 8 aligners |
| aligners | (0.2 mm; 2.0degree) | (0.4 mm; 4.0 degrees) |
| Number of lower | 16 aligners | 8 aligners |
| aligners | (0.2 mm; 2.0degree) | (0.4 mm; 4.0 degrees) |

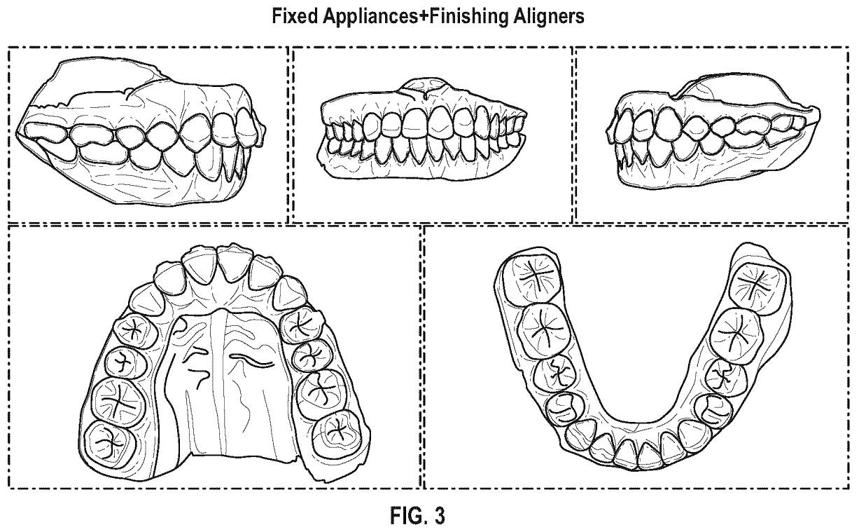

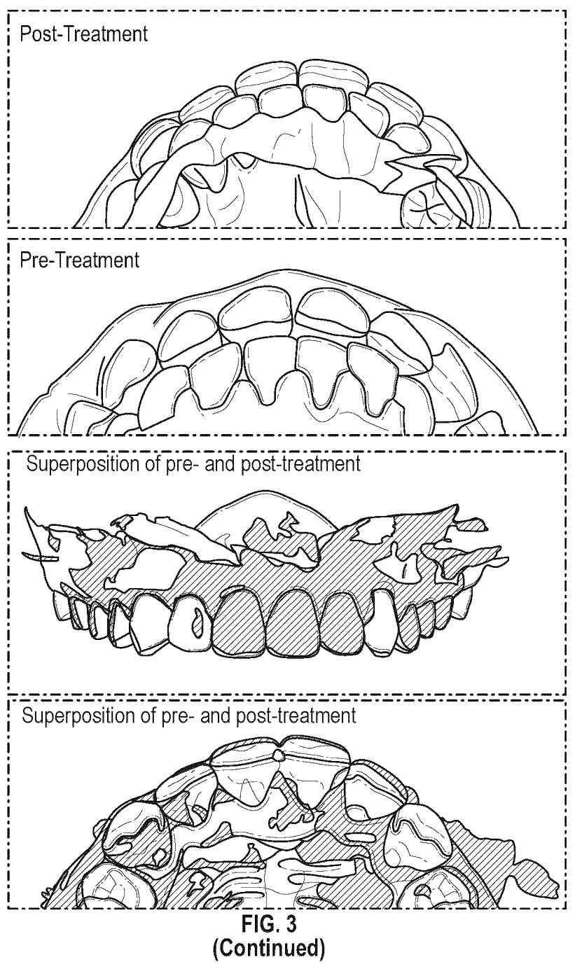

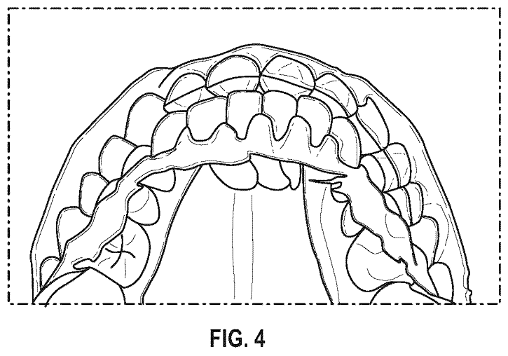

FIG. 3 shows an example of a treatment plan according to embodiments herein, including only 3 upper aligners and 2 lower aligners formed using materials of the present disclosure and applied to a patient initially planned for 6 upper aligners and 4 lower aligner (number of stages reduced by 50%). Super-positions of pre-and post-treatment are also shown from two different angles. The patient did not complain of discomfort during the treatment. FIG. 4 and Tables 6 and 7, below, illustrate a summary of tooth movement for the patient treatment plan in FIG. 3. Movements include up-righting the upper anterior (−ive, Trq, +ive buccal movements), improving the vertical position of the upper teeth (extrusion) and improving the tipping movement (mesio-distal angulation).

TABLE 6

| | | | | | | | | | | | | | | To Pdf | | | |
|---|---|---|---|---|---|---|---|---|---|---|---|---|---|---|---|---|---|
| | | Movement | | | Attachment | | IPR | | Screenshot | | Animation | | | Folder | | | |
| Upper | Lower | 8 | 7 | 6 | 5 | 4 | 3 | 2 | 1 | 1 | 2 | 3 | 4 | 5 | 6 | 7 | 8 |
| Mesial | + | — | — | — | — | −0.2 | −0.4 | −0.2 | −0.3 | 0.4 | 0.4 | −0.2 | — | — | — | — | — |
| Distal | − | | | | | | | | | | | | | | | | |
| Buccal | − | — | — | — | — | — | 0.5 | 0.2 | 0.2 | −0.1 | 0.1 | 0.2 | −0.4 | −0.4 | — | — | — |
| Lingual | + | | | | | | | | | | | | | | | | |
| Extrusion | − | — | — | — | — | — | 0.4 | 0.6 | 0.8 | 0.4 | 0.3 | — | — | — | — | — | — |
| Intrusion | + | | | | | | | | | | | | | | | | |
| Torque | + | — | — | — | — | 0.2 | — | −0.1 | −0.4 | −6.3 | −2.8 | — | — | — | — | — | — |
| Torque | − | | | | | | | | | | | | | | | | |
| Tipping | + | — | — | — | — | 2.0 | 1.5 | −2.3 | −0.1 | −3.2 | −5.3 | — | — | — | — | — | — |
| Tipping | − | | | | | | | | | | | | | | | | |
| Rotation | + | — | — | — | — | — | 3.7 | −5.6 | 0.1 | 1.1 | 2.0 | — | — | — | — | — | — |
| Rotation | − | | | | | | | | | | | | | | | | |

TABLE 7

| | | | | | | | | | | | | | | To Pdf | | | |
|---|---|---|---|---|---|---|---|---|---|---|---|---|---|---|---|---|---|
| | | Movement | | | Attachment | | IPR | | Screenshot | | Animation | | | Folder | | | |
| Upper | Lower | 8 | 7 | 6 | 5 | 4 | 3 | 2 | 1 | 1 | 2 | 3 | 4 | 5 | 6 | 7 | 8 |
| Mesial | + | — | — | — | — | 0.2 | — | −0.1 | — | — | — | — | — | — | — | — | — |
| Distal | − | | | | | | | | | | | | | | | | |
| Buccal | − | — | — | — | — | 0.1 | — | 0.4 | −0.8 | −0.6 | −0.5 | — | 0.5 | 0.4 | — | — | — |
| Lingual | + | | | | | | | | | | | | | | | | |
| Extrusion | − | — | — | — | — | 0.8 | — | — | — | — | −0.2 | — | 0.6 | 0.6 | — | — | — |
| Intrusion | + | | | | | | | | | | | | | | | | |
| Torque | + | — | — | — | — | 3.8 | — | — | — | — | — | — | 4.0 | 9.9 | — | — | — |
| Torque | − | | | | | | | | | | | | | | | | |
| Tipping | + | — | — | — | — | −2.4 | — | — | — | — | — | — | −0.3 | 0.9 | — | — | — |
| Tipping | − | | | | | | | | | | | | | | | | |
| Rotation | + | — | — | — | — | 0.2 | — | — | — | — | — | — | −0.2 | 0.1 | — | — | — |
| Rotation | − | | | | | | | | | | | | | | | | |

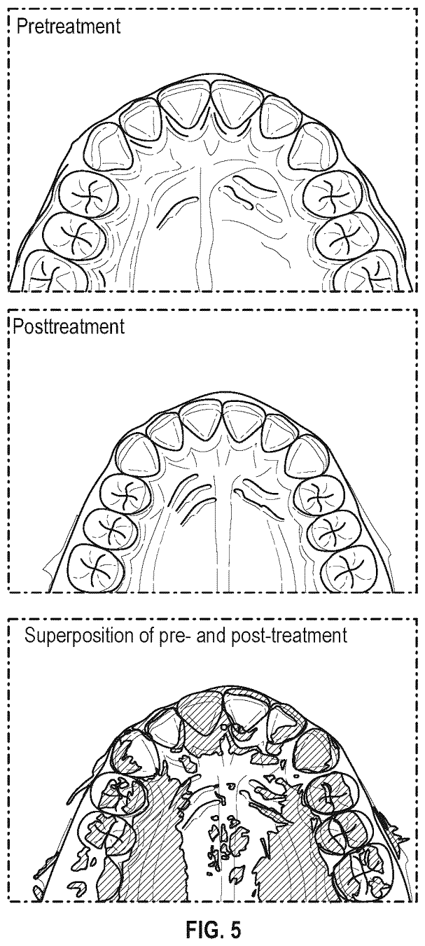

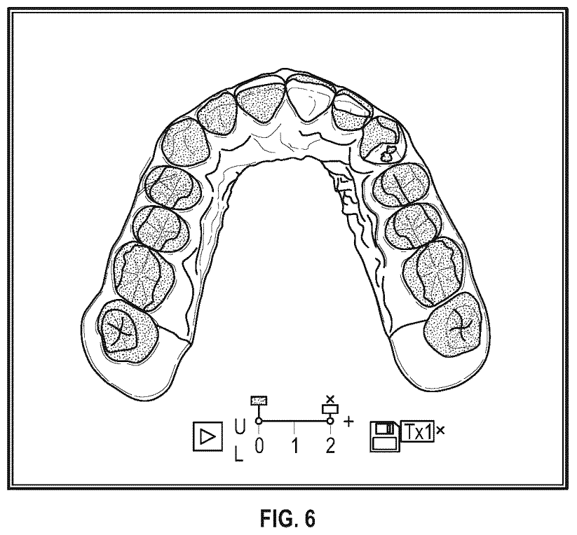

FIG. 5 shows an example of a relapse treatment plan according to embodiments herein, including using only 1 aligner for a conventional 2-stage treatment plan. The single aligner was formed using materials of the present disclosure. A super-position of pre-and post-treatment is also shown. The patient did not complain of discomfort during the treatment. FIG. 6, and table 8, below, illustrate a summary of tooth movement for the patient treatment plan in FIG. 5.

TABLE 8

| | 2 | 1 | 1 | 2 | 3 |
|---|---|---|---|---|---|
| Mesial+ | — | — | — | −0.1 | −0.2 |
| Distal− | | | | | |
| Buccal− | — | 0.4 | −0.4 | 0.3 | — |
| Lingual+ | | | | | |
| Extrusion− | — | — | — | −0.2 | — |
| Intrusion+ | | | | | |
| Torque+ | — | — | — | −3.9 | — |
| Torque− | | | | | |
| Tipping+ | — | — | — | −0.2 | — |
| Tipping− | | | | | |
| Rotation+ | — | — | — | −2.1 | — |
| Rotation− | | | | | |

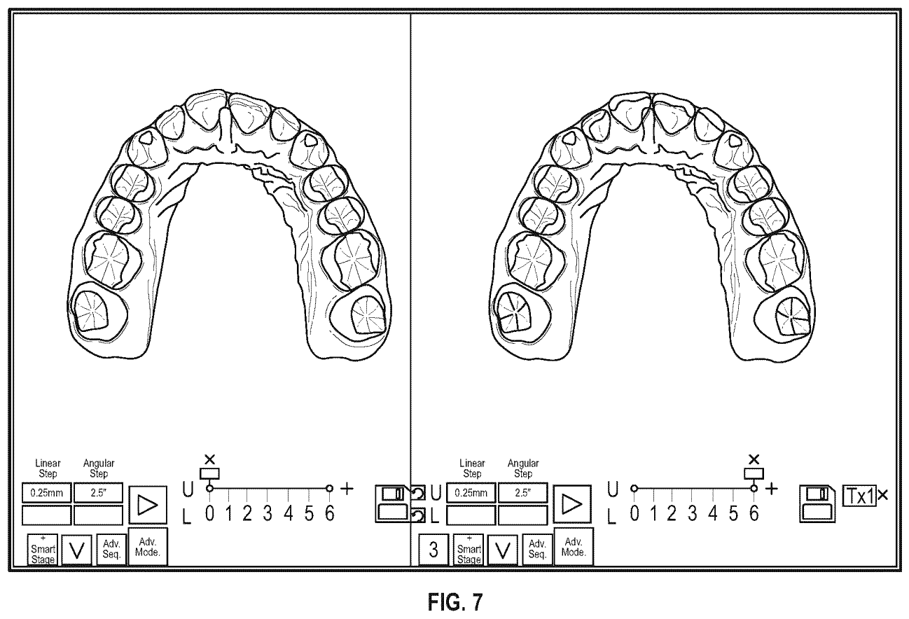

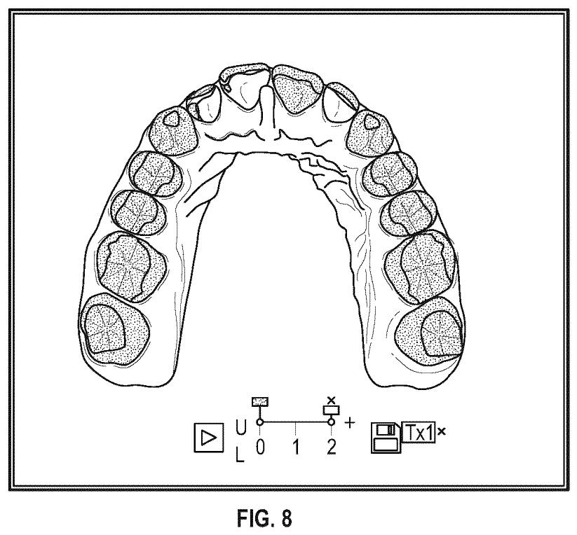

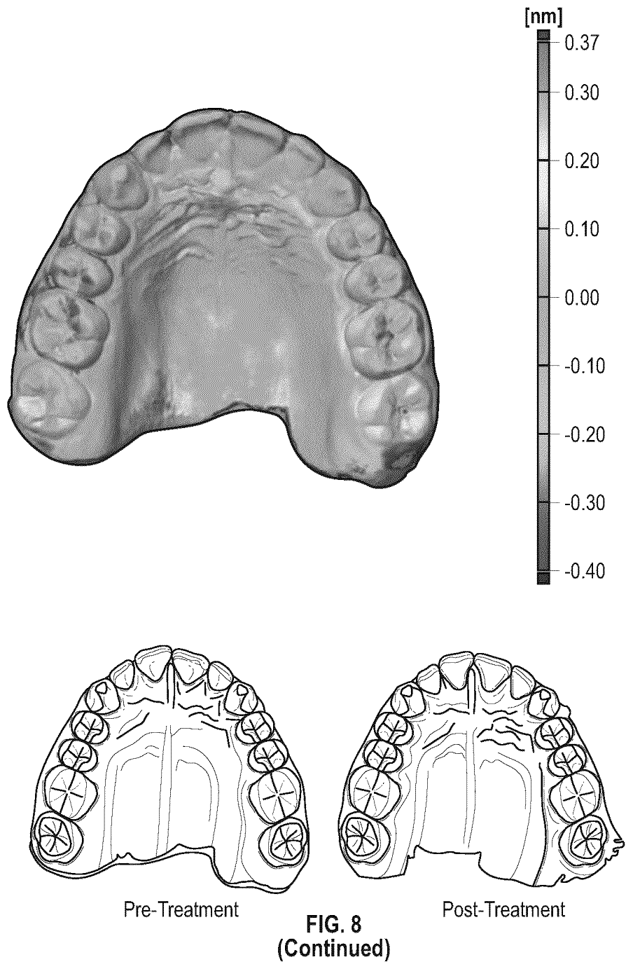

FIG. 7 shows an example of an incisor relapse treatment plan according to embodiments herein, including only 2 aligners for a conventional 6-stage treatment plan. The aligner stages were formed using materials of the present disclosure. The patient did not complain of discomfort during the treatment. FIG. 8, and table 9, below, illustrate a summary of tooth movement for the patient treatment plan in FIG. 7.

TABLE 9

| | | | | | | | | | | | | | | To Pdf | | | |
|---|---|---|---|---|---|---|---|---|---|---|---|---|---|---|---|---|---|
| | | Movement | | | Attachment | | IPR | | Screenshot | | Animation | | | Folder | | | |
| Upper | Lower | 1 | 2 | 3 | 4 | 5 | 6 | 7 | 8 | 9 | 10 | 11 | 12 | 13 | 14 | 15 | 16 |
| Mesial | + | — | — | — | — | — | — | 0.8 | — | — | — | — | — | — | — | — | — |
| Distal | − | | | | | | | | | | | | | | | | |
| Lingual | + | — | — | — | — | — | — | 0.4 | 0.4 | — | 0.4 | — | — | — | — | — | — |
| Buccal | − | | | | | | | | | | | | | | | | |
| Intrusion | + | — | — | — | — | — | — | — | — | — | — | — | — | — | — | — | — |
| Extrusion | − | | | | | | | | | | | | | | | | |
| Torque | + | — | — | — | — | — | — | 4.1 | 0.5 | — | 0.3 | — | — | — | — | — | — |
| Torque | − | | | | | | | | | | | | | | | | |
| Tipping | + | — | — | — | — | — | — | −4.7 | −1.4 | — | −2.0 | — | — | — | — | — | — |
| Tipping | − | | | | | | | | | | | | | | | | |
| Rotation | + | — | — | — | — | — | — | −13.0 | −5.8 | — | −2.0 | — | — | — | — | — | — |
| Rotation | − | | | | | | | | | | | | | | | | |

### Example

A material and treatment plans according to embodiments herein were used in evaluating tooth movements. One set of patients was treated with aligners made using a prior art material (Zendura FLX, available from Bay Materials, LLC, Fremont Ca.) and a typical aligner staging plan of 0.3 mm/3 degrees, 14 day wear cycle per aligner, herein after referred to as the FLX treatment. A second set of patients was treated with aligners made from a three layer material of an embodiment (ABA, having 50% more elastomer than Zendura FLX) wherein the A, B and C layers were constructed from the same materials as Zendura FLX. In this case the staging was increased to 0.6 mm, 6 degrees, 14 day wear cycle per aligner. This treatment is referred to as Zendura Viva.

Tooth positions before and after treatment were compared and the predicted and achieved tooth movements were calculated as well as the difference. A total of 16 teeth were treated with the FLX system and a total of 17 teeth were treated with the Zendura Viva system, using 50% fewer aligners for a comparable amount of movement. The cases evaluated between the two treatments were selected to be comparable. Both translation and rotation movements were conducted.

Table 10, below, shows the summarized data for the two treatments.

TABLE 10

| | | | | | Abs. | Predictability |
|---|---|---|---|---|---|---|
| Treatment | Tooth | Movement | Actual | Predicted | Diff. | (%) |
| FLX, Std. | 12 | BL T (mm) | 0.52 | 0.55 | 0.03 | 95.0 |
| FLX, Std. | 22 | BL T (mm) | 0.49 | 0.56 | 0.07 | 88.1 |
| FLX, Std. | 42 | BL T (mm) | 0.23 | 0.62 | 0.39 | 36.4 |
| FLX, Std. | 11 | BL T (mm) | 0.81 | 0.6 | 0.21 | 65.0 |
| FLX, Std. | 12 | BL T (mm) | 0.62 | 0.78 | 0.16 | 80.0 |
| FLX, Std. | 21 | BL T (mm) | 0.76 | 0.66 | 0.1 | 85.0 |
| FLX, Std. | 22 | BL T (mm) | 0.49 | 0.7 | 0.21 | 69.4 |
| FLX, Std. | 31 | BL T (mm) | 2.01 | 1.98 | 0.03 | 98.5 |
| FLX, Std. | 41 | BL T (mm) | 2.01 | 1.9 | 0.12 | 93.8 |
| FLX, Std. | 15 | PM MD Rot (°) | 1.48 | 1.35 | 0.13 | 90.7 |
| FLX, Std. | 25 | PM MD Rot (°) | 10.68 | 9.09 | 1.59 | 82.6 |
| FLX, Std. | 35 | PM MD Rot (°) | 4.11 | 9.8 | 5.69 | 42.0 |
| FLX, Std. | 45 | PM MD Rot (°) | 0.5 | 2.62 | 2.12 | 19.0 |
| FLX, Std. | 15 | PM MD Rot (°) | 3.15 | 4.12 | 0.97 | 76.5 |
| FLX, Std. | 35 | PM MD Rot (°) | 1.7 | 3.02 | 1.31 | 56.5 |
| FLX, Std. | 45 | PM MD Rot (°) | 8.34 | 6.69 | 1.65 | 75.3 |
| Average | | | | | | 72.1 |
| Viva-EXP | — | BL T (mm) | 0.27 | 0.38 | 0.11 | 71.4 |
| Viva-EXP | — | BL T (mm) | 0.42 | 0.51 | 0.09 | 82.9 |
| Viva-EXP | — | BL T (mm) | 0.68 | 0.8 | 0.12 | 84.6 |
| Viva-EXP | — | BL T (mm) | 0.55 | 0.84 | 0.29 | 65.8 |
| Viva-EXP | — | BL T (mm) | 0.55 | 0.61 | 0.07 | 89.2 |
| Viva-EXP | — | BL T (mm) | 0.71 | 0.84 | 0.13 | 84 |
| Viva-EXP | — | BL T (mm) | 0.78 | 0.79 | 0.02 | 97.9 |
| Viva-EXP | — | BL T (mm) | 0.55 | 0.61 | 0.07 | 89.2 |
| Viva-EXP | — | BL T (mm) | 0.71 | 0.84 | 0.13 | 84 |
| Viva-EXP | — | BL T (mm) | 0.78 | 0.79 | 0.02 | 97.9 |
| Viva-EXP | — | BL T (mm) | 0.68 | 0.93 | 0.26 | 72.4 |
| Viva-EXP | — | PM MD Rot (°) | 3.62 | 4.03 | 0.41 | 89.7 |
| Viva-EXP | — | PM MD Rot (°) | 4.61 | 6.35 | 1.75 | 72.5 |
| Viva-EXP | — | PM MD Rot (°) | 3.29 | 3.55 | 0.26 | 92.8 |
| Viva-EXP | — | PM MD Rot (°) | 3.91 | 4.97 | 1.06 | 78.6 |
| Viva-EXP | — | PM MD Rot (°) | 2.16 | 4.68 | 2.52 | 46.1 |
| Viva-EXP | — | PM MD Rot (°) | 3.91 | 4.97 | 1.06 | 78.6 |
| Average | | | | | | 81.0 |

From this data it can be seen that the experimental treatment is at least as predictable while moving teeth with fewer aligners.

It should be appreciated that the constructions and properties illustrated in the Figures and example are specific examples and not intended to limit the scope of constructions and testing that may be used. Other materials, constructions and sequences of steps may also be performed according to alternative embodiments. For example, alternative embodiments may contain additional layers including tie layers, pigments, optical additives or reinforcing agents and may be constructed in any manner known in the art such as flat sheet extrusion, coextrusion blown film, calendaring, laminating and adhesive bonding. The structures (or polymer sheets) and devices may in some embodiments be made by 3D printing or dip coating. One of ordinary skill in the art would recognize and appreciate many variations, modifications, and alternatives of the constructions.

Additional embodiments, materials, material parameters and properties, constructions methods, definitions, etc., useful for embodiments herein can be found in U.S. Pat. Nos. 10,549,511, 10,946,630, 10,870,263 and 10,987,907, which are each incorporated by reference for all purposes.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

Certain embodiments are described herein. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A system for moving one or more teeth from a first location to at least a second location for treating malocclusion according to a treatment plan, the system comprising:
a series of one or more aligners wherein at least one of the one or more aligners is comprised of a multilayer structure having at least two outer layers and at least one elastomeric inner layer,
wherein the at least one elastomeric inner layer has a thickness of greater than 250 microns up to about 775 microns and a hardness of from about Shore A80 to Shore D 65,
wherein at least one of the at least two outer layers comprises a polymer having a modulus of from about 1,000 MPa to about 3,000 MPa measured according to ASTM D638,
wherein a total thickness of the at least two outer layers and at least one elastomeric inner layer is from about 500 microns to about 1,500 microns, and
wherein the at least one of the one or more aligners is configured such that when worn for a wear time of between 10 and 15 days by a patient at least one tooth of the patient exhibits an offset movement in a mesial-distal direction and/or in a buccal-lingual direction of between about 0.35 mm to about 0.75 mm and/or at least one tooth of the patient exhibits a rotation about an axis of the at least one tooth of between about 3.5 degrees and about 7.5 degrees, and/or at least one tooth exhibits a mesial-distal tipping movement of between about 3.5 degrees and about 7 degrees.

2. The system of claim 1, wherein the at least one of the one or more aligners is configured such that when worn for the wear time by the patient two or more teeth of the patient each exhibit the offset movement of between about 0.35 mm up to about 0.75 mm.

3. The system of claim 1, wherein the at least one of the one or more aligners is configured such that when worn for the wear time by the patient 8, 10, 12 or less teeth of the patient each exhibit the offset movement of between about 0.35 mm up to about 0.75 mm.

4. The system of claim 1, wherein the at least two outer layers each comprise a co-polyester, a polycarbonate, a polyester polycarbonate blend, a polyurethane, a polyamide or a polyolefin.

5. The system of claim 1, wherein the at least one elastomeric inner layer comprises one or more of a polyurethane elastomer, a polyolefin elastomer, a polyester elastomer, a styrenic elastomer, a polyamide elastomer, a cyclic olefin elastomer, an acrylic elastomer, an aromatic or aliphatic polyether polyurethane and a polyester polyurethane.

6. The system of claim 5, wherein the at least two outer layers each comprise a co-polyester.

7. The system of claim 1, wherein the at least one elastomeric inner layer has a modulus of from about 25 MPa to 500 MPa measured according to ASTM D638.

8. The system claim 1, wherein the at least one aligner further comprises one or more tie layers.

9. The system of claim 1, wherein the treatment plan is determined by reducing a number of treatment stages in an initial treatment plan involving a first plurality of treatment stages each designed to effect an offset movement for at least one tooth of less than 0.3 mm, to a second plurality of treatment stages including the series of two or more aligners, wherein the number of treatment stages in the first plurality of treatment stages is greater than a number of treatment stages in the second plurality of treatment stages.

10. A system for moving one or more teeth from a first location to at least a second location for treating malocclusion according to a treatment plan, the system comprising:
a series of two or more aligners wherein each of the two or more aligners is comprised of a multilayer structure having at least two outer layers and at least one elastomeric inner layer,
wherein the at least one elastomeric inner layer has a thickness of greater than 250 microns up to about 775 microns and a hardness of from about Shore A80 to Shore D 65,
wherein at least one of the at least two outer layers comprises a polymer having a modulus of from about 1,000 MPa to about 3,000 MPa measured according to ASTM D638,
wherein a total thickness of the at least two outer layers and at least one elastomeric inner layer is from about 500 microns to about 1,500 microns,
wherein the two or more aligners are each configured such that when worn for a wear time of between 10 and 15 days by a patient at least one tooth of the patient exhibits an offset movement in a mesial-distal direction and/or in a buccal-lingual direction of between about 0.35 mm to about 0.75 mm and/or at least one tooth of the patient exhibits a rotation about an axis of the at least one tooth of between about 3.5 degrees and about 7 degrees, and/or at least one tooth exhibits a mesial-distal tipping movement of between about 3.5 degrees and about 7 degrees.

11. The system of claim 10, wherein each of the two or more aligners is configured such that when worn for the wear time by the patient two or more teeth of the patient each exhibit the offset movement of between about 0.35 mm up to about 0.75 mm.

12. The system of claim 10, wherein each of the two or more aligners is configured such that when worn for the wear time by the patient 8, 10, 12 or less teeth of the patient each exhibit the offset movement of between about 0.35 mm up to about 0.75 mm.

13. The system of claim 10, wherein the at least two outer layers each comprise a co-polyester, a polycarbonate, a polyester polycarbonate blend, a polyurethane, a polyamide or a polyolefin.

14. The system of claim 10, wherein the at least one elastomeric inner layer of each of the two or more aligners comprises one or more of a polyurethane elastomer, a polyolefin elastomer, a polyester elastomer, a styrenic elastomer, a polyamide elastomer, a cyclic olefin elastomer, an acrylic elastomer, an aromatic or aliphatic polyether polyurethane and a polyester polyurethane.

15. The system of claim 14, wherein the at least two outer layers of each of the two or more aligners each comprise a co-polyester.

16. The system of claim 10, wherein the at least one elastomeric inner layer of each of the two or more aligners has a modulus of from about 25 MPa to 500 MPa measured according to ASTM D638.

17. The system claim 10, wherein each of the two or more aligners further comprises one or more tie layers.

18. The system of claim 10, wherein the treatment plan is determined by reducing a number of treatment stages in an initial treatment plan involving a first plurality of treatment stages each designed to effect an offset movement for at least one tooth of less than 0.3 mm, to a second plurality of treatment stages including the series of two or more aligners, wherein the number of treatment stages in the first plurality of treatment stages is greater than a number of treatment stages in the second plurality of treatment stages.

19. A system for moving one or more teeth for treating malocclusion according to a treatment plan comprising two or more stages, the system comprising:
a series of one or more aligners wherein at least one of the one or more aligners is comprised of a multilayer structure having at least two outer layers and at least one elastomeric inner layer,
wherein the at least one elastomeric inner layer has a thickness of greater than 250microns up to about 775 microns and a hardness of from about Shore A80 to Shore D 65,
wherein at least one of the at least two outer layers comprises a polymer having a modulus of from about 1,000 MPa to about 3,000 MPa measured according to ASTM D638,
wherein a total thickness of the at least two outer layers and at least one elastomeric inner layer is from about 500 microns to about 1,500 microns, and
wherein the at least one of the one or more aligners is configured to effect, over one treatment stage, one or more of an offset movement of least one tooth, a rotation of the at least one tooth and a mesial-distal tipping of the at least one tooth, wherein the offset movement is in a mesial-distal direction and/or in a buccal-lingual direction of between about 0.35 mm to about 0.75 mm, wherein the rotation is about a tooth axis of between about 3.5 degrees and about 7.5 degrees, and wherein the mesial-distal tipping movement is between about 3.5 degrees and about 7 degrees.
